(19) United States
(12) Patent Application Publication
(10) Pub. No.: US 2026/0090958 A1
(43) Pub. Date: Apr. 2, 2026

(54) NASOGASTRIC TUBE STRUCTURE

(71) Applicant: Taipei Medical University, Taipei City (TW)

(72) Inventors: Pai-Chien Chou, Taipei City (TW); Chien-Hua Chen, Taipei City (TW); Hsueh-Lien Su, Taipei City (TW); Ya-Ting Juang, Taipei City (TW)

(21) Appl. No.: 19/341,268

(22) Filed: Sep. 26, 2025

(30) Foreign Application Priority Data
Sep. 27, 2024 (TW) 113136833

(51) Int. Cl. A61J 15/00

(52) U.S. Cl. CPC A61J 15/0003; A61J 15/0026

(57) ABSTRACT

Provided is a nasogastric tube structure including a temperature-controllable and deformable wire embedded within the wall of a flexible tube. The wire deforms in response to temperature changes, thereby altering the diameter of the tube. This allows the nasogastric tube to be inserted with a reduced diameter, enhancing patient comfort during the procedure. After the nasogastric tube is in place, the tube expands to a larger diameter as the wire deforms, facilitating the patient’s feeding and medication administration.

### CROSS-REFERENCE TO RELATED APPLICATION

Priority is claimed on Taiwanese Patent Application No. 113136833, filed September 27, 2024, the content of which is incorporated herein by reference.

### TECHNICAL FIELD

The present disclosure relates to a nasogastric tube structure, and more particularly to an improved nasogastric tube structure for medical use.

### BACKGROUND

Currently, nasogastric tubes have been widely used for patients unable to eat by oral mastication. When using a nasogastric tube, a guide tube is first inserted through the patient’s nasal cavity directly to the patient’s stomach, and then through a feeding device such as a syringe, the patient’s required food or medication is delivered to the patient’s stomach via the guide tube, thereby assisting the patient with feeding or medication administration.

However, conventional nasogastric tubes must have a certain tube diameter size due to feeding requirements, so that the patient’s required food or medication can pass smoothly. Nevertheless, the excessive tube diameter of conventional nasogastric tubes often causes compression on the patient’s nasal cavity or throat, thereby causing patient discomfort and even leading to clinical complications such as nasal cavity inflammation, sinusitis, and pharyngitis. On the other hand, in order to avoid the above-mentioned problem of excessive tube diameter size by reducing the tube diameter of the guide tube, in addition to possibly increasing feeding difficulty due to increased resistance, it may also cause the guide tube to have excessively soft hardness due to the wall of the guide tube being too thin. This results in insufficient support force during the process of placing the nasogastric tube, increasing the difficulty for the operator to place the nasogastric tube, and even leading to reduced willingness of the patient to cooperate due to extreme discomfort, thereby indirectly causing greater difficulty for the operator to place the nasogastric tube.

Therefore, how to overcome the various problems of the above-mentioned conventional technology has currently become an urgent issue to be solved.

### SUMMARY

In view of the various deficiencies of the above-mentioned conventional technology, the present disclosure provides a nasogastric tube structure comprising: a flexible tube having a first end section and a second end section; and a temperature-controllable and deformable wire embedded within the wall of the flexible tube.

In at least one embodiment of the present disclosure, the flexible tube is made of an insulating material.

In at least one embodiment of the present disclosure, the flexible tube is inwardly recessed toward the center of the flexible tube on a portion of an outer peripheral surface of the wall.

In at least one embodiment of the present disclosure, the wire includes a plurality of annular structures, and each of the annular structures has a notch and is spaced and stacked in arrangement with each other.

In at least one embodiment of the present disclosure, the width of the notch of the annular structure at a first temperature is less than the width of the notch of the annular structure at a second temperature.

In at least one embodiment of the present disclosure, the plurality of annular structures are embedded in at least one of the first end section and the second end section of the flexible tube.

In at least one embodiment of the present disclosure, at least two of the plurality of annular structures have notches of different widths.

In at least one embodiment of the present disclosure, the wire further includes a rod-shaped structure, and at least one end of the rod-shaped structure is exposed from the flexible tube.

In at least one embodiment of the present disclosure, the plurality of annular structures are interconnected by the rod-shaped structure.

In at least one embodiment of the present disclosure, the temperature-controllable and deformable wire is made of a shape memory alloy. In some embodiments of the present disclosure, the shape memory alloy is a nickel-titanium alloy.

In at least one embodiment, the nasogastric tube structure of the present disclosure embeds a temperature-controllable and deformable wire within the wall of the flexible tube, so that the wire deforms in response to temperature changes, thereby altering the diameter of the flexible tube. Therefore, compared to conventional technology, the nasogastric tube structure of the present disclosure can facilitate performing nasogastric tube insertion procedures with a reduced diameter, enhancing patient comfort. Also, after completing the nasogastric tube insertion, the flexible tube can expand to a larger diameter as the wire deforms, facilitating the patient’s feeding and medication administration.

### BRIEF DESCRIPTION OF THE DRAWINGS

Through reading the description of the following embodiments and referring to the accompanying drawings, the present disclosure can be more fully understood.

FIG. 1A is a top schematic view of the nasogastric tube structure of the present disclosure.

FIG. 1B is a side schematic view of the nasogastric tube structure of the present disclosure.

FIG. 1C and FIG. 1D are partial top schematic views of the nasogastric tube structure of the present disclosure during temperature change.

FIG. 2A is a side schematic view of the nasogastric tube structure of the present disclosure in one application example.

FIG. 2B is a side schematic view of FIG. 2A from another view angle.

FIG. 2C is a side schematic view of FIG. 2B during temperature change.

FIG. 2D is a side schematic view of another embodiment of FIG. 2A.

FIG. 3A is a side schematic view of yet another embodiment of FIG. 2A.

FIG. 3B and FIG. 3C are partial top schematic views of different end regions shown in FIG. 3A.

### DETAILED DESCRIPTION

The following illustrates embodiments of the present disclosure by means of examples, and those skilled in the art can easily understand other advantages and effects of the present disclosure from the content disclosed by the present disclosure.

It should be understood that the structures, proportions, and dimensions illustrated in the drawings attached to the present disclosure are only used to accompany the content disclosed in the specification for understanding and reading by those skilled in the art and are not intended to limit the conditions for implementing the present disclosure. Therefore, any structural modifications, changes in proportional relationships, or adjustments in size dimensions, without affecting the effects that the present disclosure can produce and the objectives that can be achieved, should still fall within the scope that can be covered by the technical content disclosed by the present disclosure.

As used herein, the terms such as “upper,” “lower,” “inner,” “outer,” “front,” and “rear” are only for convenience of description and are not intended to limit the scope of implementation of the present disclosure. Changes or adjustments in their relative relationships, without substantial changes to the technical content, should be considered as falling within the implementable scope of the present disclosure.

As used herein, the use of the term “a” or “an” to describe elements and components described herein is merely for convenience of description and provides general meaning to the scope of the present disclosure. Therefore, unless clearly indicating otherwise, such description should be understood to include one or at least one, and the singular also includes the plural.

As used herein, the terms “first” or “second” and similar ordinal terms are primarily used to distinguish or refer to the same or similar elements or structures and do not necessarily imply spatial or temporal order of such elements or structures. It should be understood that in certain circumstances or aspects, ordinal terms may be used interchangeably without affecting the implementation of the present disclosure.

Furthermore, as used herein, the terms “including,” “comprising,” “having,” or any other similar terms are intended to cover non-exclusive inclusions. For example, an element or structure containing a plurality of elements is not limited only to such elements listed herein and may include other elements not explicitly listed but that are normally inherent to such element or structure.

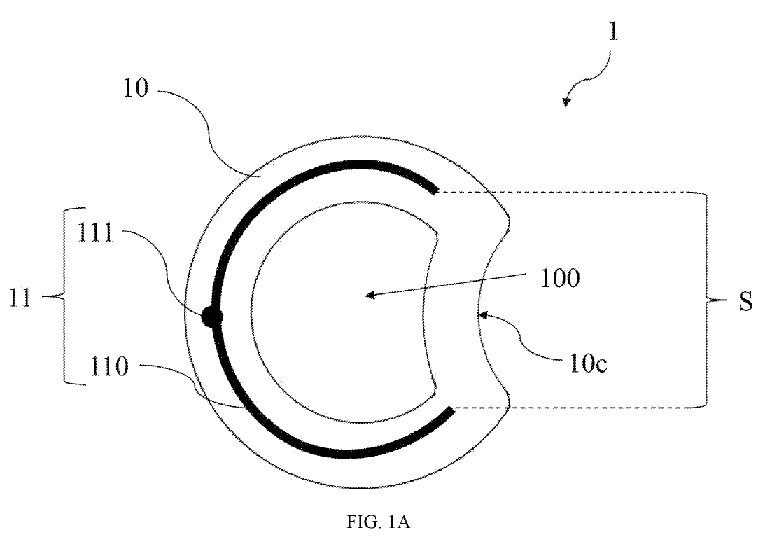

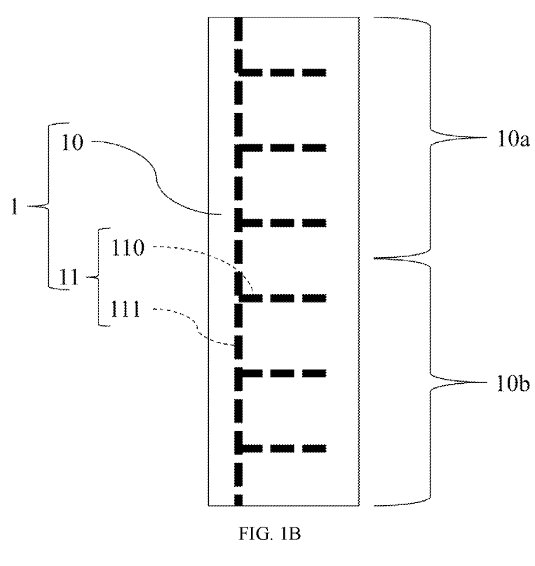

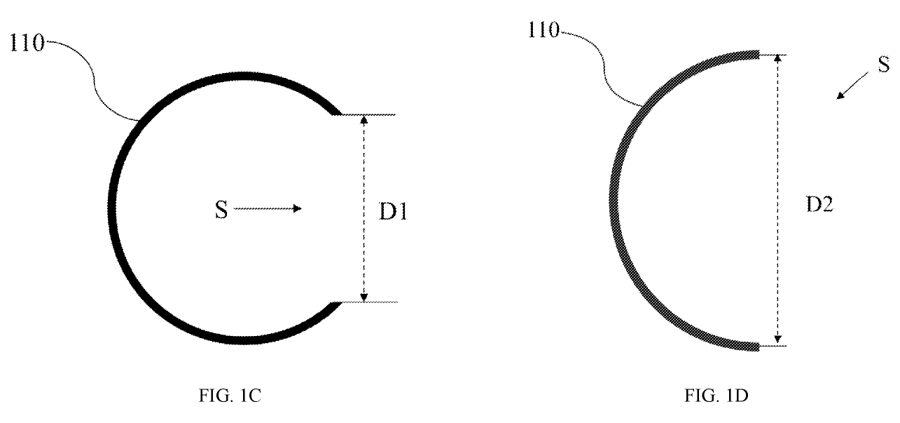

Referring to FIG. 1A and FIG. 1B, these are respectively top and side schematic views of the nasogastric tube structure 1 of the present disclosure. In at least one embodiment, the nasogastric tube structure 1 of the present disclosure includes a flexible tube 10 and a temperature-controllable and deformable wire 11 covered by the flexible tube 10.

In at least one embodiment, the flexible tube 10 of the present disclosure is made of insulating materials, such as polyvinyl chloride (PVC), polyurethane (PU), or silicone, but is not limited thereto. In some embodiments of the present disclosure, the flexible tube 10 is made of a biocompatible material and thus can be used as invasive medical devices.

As shown in FIG. 1B, in at least one embodiment of the present disclosure, the flexible tube 10 has a first end section 10a and a second end section 10b opposed to the first end section 10a. Also, as shown in FIG. 1A, in some embodiments of the present disclosure, the flexible tube 10 may be inwardly recessed toward the center of the flexible tube 10 on a portion of an outer peripheral surface of the wall 10c, so that the channel 100 from the first end section 10a to the second end section 10b forms a non-circular perforation.

Similarly, as shown in FIG. 1A, in at least one embodiment of the present disclosure, the wire 11 includes at least one annular structure 110 having a notch S, such as a C-shaped ring or an arc-shaped ring, and as shown in FIG. 1B, a plurality of annular structures 110 from the first end section 10a to the second end section 10b are spaced and stacked in arrangement with each other. In at least one embodiment of the present disclosure, the wire 11 includes a rod-shaped structure 111 connecting the plurality of annular structures 110. In some embodiments of the present disclosure, the rod-shaped structure 111 connects the plurality of annular structures 110 in series, such as connecting at the positions near the center on the annular arc wire of each annular structure 110, to form a keel-shaped wire 11.

Furthermore, as shown in FIG. 1A, in at least one embodiment of the present disclosure, the wire 11 is embedded within the wall 10c of the flexible tube 10 and is made of a temperature-controllable and deformable (such as thermally deformable) material, for example, a shape memory alloy (SMA) such as a nickel-titanium alloy. In some embodiments of the present disclosure, the temperature-controllable and deformable material may be a non-magnetic alloy of nickel and titanium, for example, nitinol, which is an alloy material composed of nickel and titanium in an atomic ratio of 1:1, with nickel atoms accounting for 50% and the weight ratio being approximately 55%.

In at least one embodiment of the present disclosure, the shape memory alloy has non-linear superelastic characteristics and good corrosion resistance because it is a dual-phase alloy. In some embodiments of the present disclosure, the nickel-titanium alloy has tissue characteristics similar to human hair, bones, and tendons, and can achieve a strain rate of approximately 10%. Since its strain rate has a non-linear relationship with external force, the nickel-titanium alloy can recover from deformation with minimal stress once the external force is removed, due to its super elasticity.

For example, when using temperatures above 40°C for the original form, the alloy material will undergo deformation due to stress when cooled from the austenite finish (Af) temperature above 40°C to the martensite finish (Mf) temperature below 30°C to form martensite. Moreover, when reheated to 40°C, the material will undergo reverse phase transformation, causing the alloy material to return to its original form.

It should be understood that the shape memory effect of the nickel-titanium alloy is a phase transformation process triggered by thermal intervals. In some embodiments of the present disclosure, the temperature range of the phase transformation of the shape memory alloy can be selected according to actual requirements, which will depend on the composition ratio of nickel and titanium in the alloy. For example, by adjusting the weight ratio of nickel in nitinol to 54% to 57%, with the remainder being titanium, the shape memory alloy used in the wire 11 can be designed according to actual requirements and achieve the design purpose of “superelasticity” or “shape memory characteristics” by applying its phase transformation temperature range and nickel-titanium composition ratio.

As shown in FIG. 1C and FIG. 1D, in at least one embodiment of the present disclosure, the wire 11 can be designed so that in a lower temperature environment (such as room temperature), the annular structure 110 made of a shape memory alloy has a smaller notch S (as shown in FIG. 1C), while in a higher temperature environment (such as body temperature), it will form a larger notch S (as shown in FIG. 1D). This results in the width D1 of the notch S of the annular structure 110 at a first temperature (lower temperature) (as shown in FIG. 1C) being less than the width D2 of the notch S of the annular structure 110 at a second temperature (higher temperature) (as shown in FIG. 1D). Therefore, when the wire 11 is covered within the flexible tube 10 made of a material such as silicone, its deformation will simultaneously change the inner diameter size of the channel 100 of the flexible tube 10.

In at least one embodiment of the present disclosure, the rod-shaped structure 111 of the wire 11 can serve as a conductive path, which is designed to be exposed at the end of the flexible tube 10 to utilize the temperature required for deformation generated by resistance when current passes through, thereby achieving the deformation effect produced by temperature change. It should be understood that in some embodiments of the present disclosure, the degree of temperature control layout of the wire 11 can be designed according to actual requirements; that is, the magnitude of deformation produced by the temperature range can be designed according to actual requirements, and there is no particular limitation in the present disclosure.

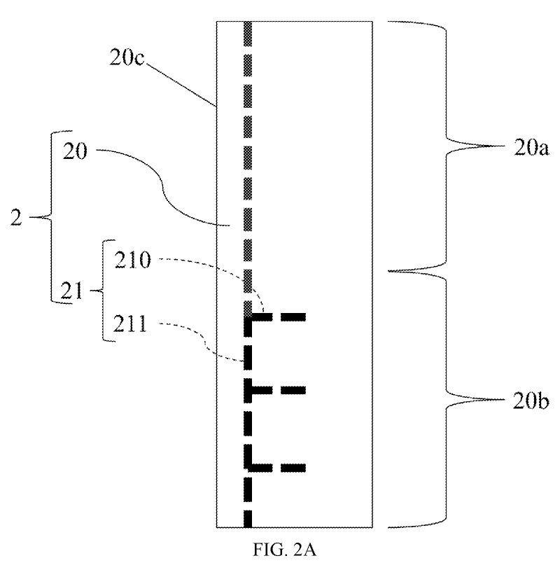

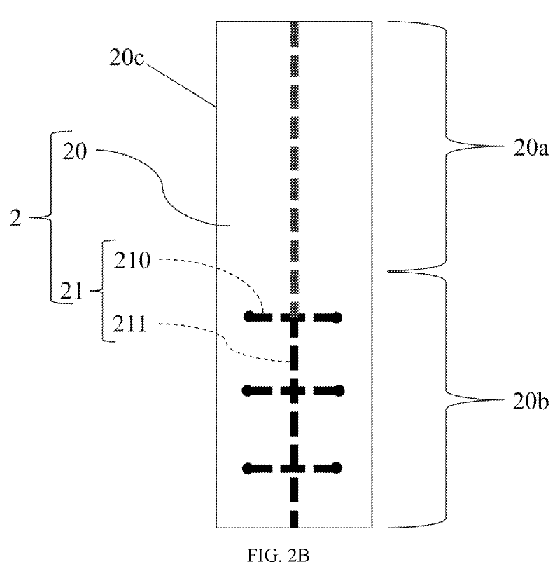

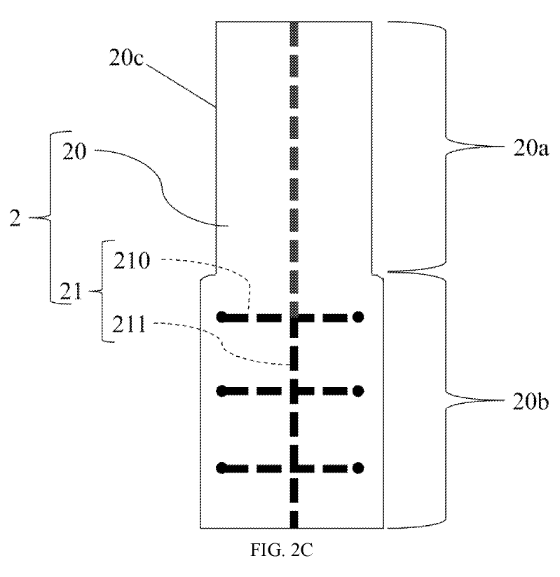

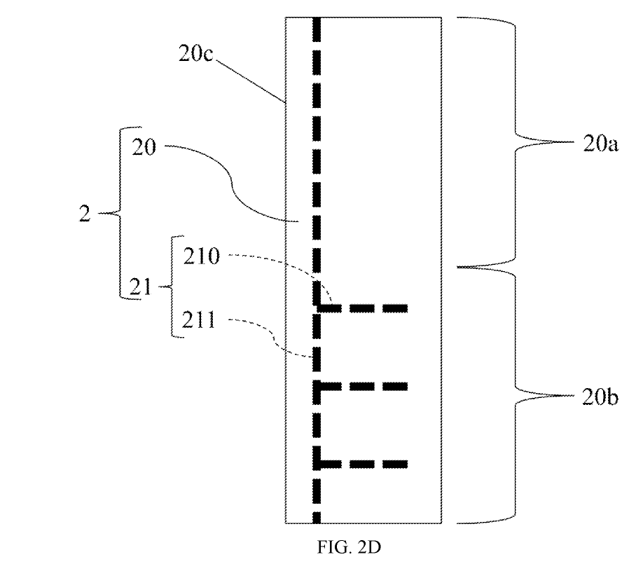

Referring to FIG. 2A, this is a side schematic view of the nasogastric tube structure 2 of the present disclosure in one application example. In at least one embodiment of the present disclosure, the annular structure 210 of the wire 21 is embedded in the wall 20c of a partial section of the flexible tube 20. For example, in some embodiments of the present disclosure, the first end section 20a of the flexible tube 20 serves as the nasal region section, while the second end section 20b of the flexible tube 20 serves as the gastric region section, so that the annular structure 210 is only embedded in the second end section 20b (i.e., the gastric region section) of the flexible tube 20.

In at least one embodiment, the nasogastric tube structure 2 of the present disclosure can change the inner diameter size of the flexible tube 20 with temperature change. For example, in at least one embodiment of the present disclosure, when inserting the nasogastric tube, the annular structure 210, due to lower temperature (such as below body temperature), will cause the tube diameter of the flexible tube 20 to be smaller (as shown in FIG. 2B), so as to improve and reduce the discomfort caused to patients during nasogastric tube insertion. In other embodiments of the present disclosure, after the nasogastric tube has been inserted into the patient’s body, the annular structure 210 in the second end section 20b of the flexible tube 20, due to temperature increase (such as warming due to body temperature), will cause the tube diameter of the flexible tube 20 to become larger (as shown in FIG. 2C), thereby making the channel through which the flexible tube 20 can pass larger and thus reducing the difficulty of feeding or medication administration that facilitate operations of feeding or medication administration. This can even provide patients with food supply of larger molecules such as fiber. It should be understood that, as shown in FIG. 2D, in at least one embodiment of the present disclosure, the rod-shaped structure 211 of the wire 21 can be utilized as a conductive path, and through its exposure at the end of the flexible tube 20, to connect to a power source and achieve the effect of temperature change.

Furthermore, as shown in FIG. 2A, in at least one embodiment of the present disclosure, the annular structure 210 made of a shape memory alloy can be disposed at the second end section 20b of the nasogastric tube away from the nasal-oral end, while the first end section 20a near the nasal-oral end has no annular structure 210 disposed. By using the flexible tube 20 with reduced tube diameter, this further reduces the compressive force on the patient’s nasal passages and throat after nasogastric tube insertion, not only enhancing patient comfort, but also reducing many conditions such as nasal congestion, nasal cavity inflammation, sinusitis, pharyngitis, and throat swelling.

In at least one embodiment, the nasogastric tube structure 2 of the present disclosure employs a rod-shaped structure 211 made of a linear shape memory alloy, which can provide the nasogastric tube with sufficient support and appropriate flexibility, thereby enabling the operator to easily place the nasogastric tube and allowing the nasogastric tube to be smoothly inserted directly into the patient’s stomach. Therefore, compared to the conventional nasogastric tube’s soft tube design, this can better avoid the problem of insufficient support caused by the soft tube being too soft during nasogastric tube placement and even avoid the problem of tube knotting that easily occurs during nasogastric tube placement. In some embodiments of the present disclosure, due to the use of a shape memory alloy, this can thus reduce the need to use existing nasogastric tubes with thicker diameters to maintain tube strength. As shown in FIG. 2D, in some embodiments of the present disclosure, the rod-shaped structure 211 can also extend from the first end section 20a to the second end section 20b of the nasogastric tube, so as to enhance support for the nasogastric tube, thereby making nasogastric tube placement operations easier.

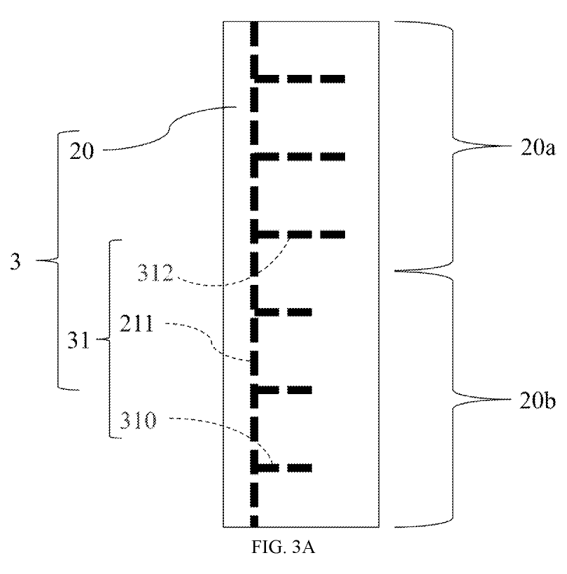

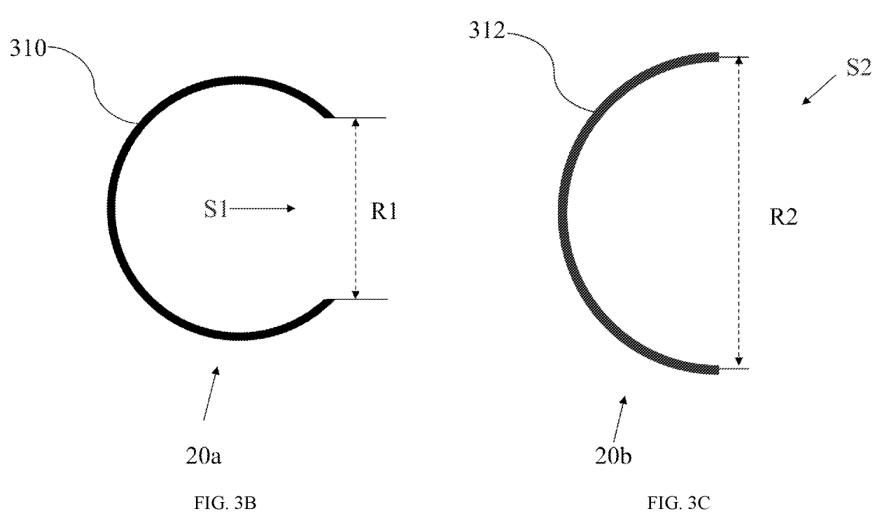

In at least one embodiment of the present disclosure, by adjusting the tube diameter changes of the first end section 20a and the second end section 20b of the flexible tube 20, the requirements of nasogastric tube placement comfort and patient feeding convenience can be simultaneously satisfied. As shown in FIG. 3A, in some embodiments of the present disclosure, the second annular structure 310 made of a shape memory alloy in the wire 31 can be disposed at the first end section 20a of the nasogastric tube near the nasal-oral end, where the width of its notch can be smaller than the width of the notch of the first annular structure 312 disposed at the second end section 20b of the nasogastric tube away from the nasal-oral end.

For example, as further shown in FIG. 3B and FIG. 3C, the first end section 20a and the second end section 20b of the flexible tube 20 have the first annular structure 312 and the second annular structure 310, respectively, with different notch sizes at the same temperature state, where the first notch S1 of the second annular structure 310 has a first width R1, and the second notch S2 of the first annular structure 312 has a second width R2, and where the first width R1 is less than the second width R2.

In some embodiments of the present disclosure, a plurality of annular structures in the direction from the first end section 20a toward the second end section 20b can be arranged in a manner of C-shaped rings with progressively smaller notches, so that the width of each notch gradually decreases from the first end section 20a near the nasal-oral end toward the second end section 20b away from the nasal-oral end, thereby improving the tube diameter size required by the flexible tube 20 at different positions through temperature differences.

Accordingly, in some embodiments, the nasogastric tube structure of the present disclosure includes a wire made of a shape memory alloy, which may serve as a guide wire during the placement of the nasogastric tube. By virtue of the configuration of the annular structure, the placement of the nasogastric tube can be facilitated, and, through subsequent thermally induced deformation effects, the operation of feeding or medication administration to the patient can be further improved.

Furthermore, in some embodiments, the nasogastric tube structure of the present disclosure utilizes different designs and/or positioning of the annular structures, combined with the wire made of a shape memory alloy that contracts the notch at lower temperatures to reduce the tube diameter and expands the notch at higher temperatures to enlarge the tube diameter. Hence, the nasogastric tube structure of the present disclosure can effectively address the high resistance problem during feeding or medication administration that results from conventional tube diameters being too small.

Additionally, in some embodiments of the present disclosure, the inward recession design on a portion of an outer peripheral surface of the tube wall modifies the nasogastric tube’s shape. When combined with the wire made of a shape memory alloy embedded within the tube, this design allows the tube diameter to be further reduced during non-feeding or non-medication periods, while enabling timely expansion when feeding or medication administration is required. Therefore, by applying the inward recession design and different material combinations in the tube of the nasogastric tube structure of the present disclosure, the nasogastric tube channel can dynamically adjust its inner diameter through the deformation of the shape memory alloy.

In other embodiments, the wire of the present disclosure may be electrically connected to a power source through an exposed end section of the tube, and the rod-shaped structure of the wire may serve as a conductive path, such that, upon connection to the power source, the temperature variation of the wire may be controlled, thereby changing the diameter of the nasogastric tube through the deformation of the shape memory alloy.

In some embodiments of the present disclosure, the wire can also be connected to an additional temperature control unit through its exposure at the tube end, so as to control temperature variation of the wire, thereby changing the nasogastric tube diameter through the deformation of the shape memory alloy.

In some embodiments, the nasogastric tube of the present disclosure employs a wire made of a recyclable shape memory alloy, thereby effectively addressing medical waste issues.

At least based on the foregoing description, the nasogastric tube structure of the present disclosure may include a shape memory alloy embedded within the tube wall, in combination with the control of temperature variation, to thereby adjust the inner diameter of the nasogastric tube. The nasogastric tube may be placed into the patient’s body in a small-diameter state so as to enhance patient comfort, and, after completion of the placement, the tube may be deformed into a large-diameter state so as to facilitate feeding and medication administration to the patient.

Furthermore, the nasogastric tube structure of the present disclosure not only effectively prevents nasal cavity inflammation, sinusitis, pharyngitis, swallowing difficulties, and other clinical complications in patients, but also optimizes food or medication flow rates through the nasogastric tube via diameter expansion. This reduces tube lumen resistance, enabling operators to better assess appropriate insertion pressure, thereby improving gastric reflux conditions and reducing other complications that may result from nasogastric tube placement.

The above embodiments are provided solely to illustrate the principles and effectiveness of the present disclosure and are not intended to limit the scope thereof. Furthermore, while at least one exemplary embodiment has been presented in the foregoing description, it should be understood that numerous variations of the present disclosure may exist. It should likewise be understood that the embodiments described herein are not intended to limit in any manner the scope, use, or configuration of the claimed subject matter. Rather, the foregoing description provides those skilled in the art with a convenient guide for implementing one or more embodiments as described herein. Accordingly, the scope of the present disclosure should be determined by the appended claims.

What is claimed is:

1. A nasogastric tube structure, comprising:
a flexible tube having a first end section and a second end section; and
a temperature-controllable and deformable wire embedded within a wall of the flexible tube.

2. The nasogastric tube structure of claim 1, wherein the flexible tube is made of an insulating material.

3. The nasogastric tube structure of claim 1, wherein the flexible tube is inwardly recessed toward a center of the flexible tube on a portion of an outer peripheral surface of the wall.

4. The nasogastric tube structure of claim 1, wherein the wire includes a plurality of annular structures, each of the annular structures having a notch and being spaced and stacked in arrangement with each other.

5. The nasogastric tube structure of claim 4, wherein the plurality of annular structures are embedded in at least one of the first end section and the second end section of the flexible tube.

6. The nasogastric tube structure of claim 4, wherein at least two of the plurality of annular structures have notches of different widths.

7. The nasogastric tube structure of claim 4, wherein the wire further includes a rod-shaped structure, and at least one end of the rod-shaped structure is exposed from the flexible tube.

8. The nasogastric tube structure of claim 7, wherein the plurality of annular structures are interconnected by the rod-shaped structure.

9. The nasogastric tube structure of claim 1, wherein the wire is made of a shape memory alloy.

10. The nasogastric tube structure of claim 9, wherein the shape memory alloy is a nickel-titanium alloy.
